(19) United States
(12) Patent Application Publication
(10) Pub. No.: US 2016/0145413 A1
(43) Pub. Date: May 26, 2016

(54) Disposable items and methods utilizing flexible bioplastic resins

(71) Applicant: Shantu Patel, Carlsbad, CA (US)

(72) Inventor: Shantu Patel, Carlsbad, CA (US)

(21) Appl. No.: 14/948,335

(22) Filed: Nov. 22, 2015

Related U.S. Application Data
(63) Continuation-in-part of application No. 14/553,437, filed on Nov. 25, 2014.
Application No. 14/553,437 is a continuation-in-part of application No. 14/553,479, filed on Nov. 25, 2014.

(51) Int. Cl. C08K 5/11

(52) U.S. Cl. CPC C08K 5/11

(57) ABSTRACT

Disposable items and methods utilizing flexible bioplastic resins include providing a bioplastic resin; and mixing the bioplastic resin with a biodegradable plasticizer that includes acetyl tributyl citrate (ATBC); thereby providing a flexible biodegradable material. Embodiments include forming the flexible biodegradable material into a device, wherein the bioplastic resin is polylactic acid (PLA); and the flexible biodegradable material is 5 to 35% ATBC by weight. Embodiments include a syringe, a multidose syringe, a needle cap and needle safety shield, a specimen tube, a scalpel, a lancet, a sharps container, a suction canister, an ink cartridge, and a toner cartridge.

### RELATED APPLICATIONS

This application claims the benefit of the filing date of U.S. patent application Ser. No. 14/553,437, filed Nov. 25, 2014, (PA010-107C), which is incorporated herein by reference in its entirety, and U.S. patent application Ser. No. 14/553,479, filed Nov. 25, 2014, (PA010-107E), which is incorporated herein by reference in its entirety.

### BACKGROUND OF THE INVENTION

The present invention generally relates to disposable items made from flexible bioplastic resins.

Environment and sustainability have become increasingly important factors in the design and specification of medical and printing articles across the world. In hospitals, pharmaceuticals, life sciences, and healthcare industries, safe disposal of articles after use is an important issue. Special considerations are given to selecting materials in the final design for disposable articles, so as to reduce the quantity of syringes items that enter waste streams. These facilities and industries must initiate environmentally safe disposal methods because they generate a large amount of the bio waste. Due to higher social responsibility and environmental concerns, corporations are being driven to produce more sustainable and environmentally safe products through government regulations, by institutional investors, and through consumer demand.

Polylactic acid (PLA) is a transparent bioplastic produced from corn, beet and cane sugar. It not only resembles conventional petrochemical mass plastics, such as polyethylene (PE), polyethylene terephthalate (PET or PETE), and polypropylene (PP) in its characteristics, but it can also be processed easily on standard equipment that already exists for the production of conventional plastics. PLA has a density of 1.25 to 3 g cm, which lower than PET, and PLA has a refractive index of 1.35-1.45, which is lower than PET, which has a refractive index of 1.54. PLA is currently used in biomedical applications, such as sutures, stents, dialysis media and drug delivery devices. It is also being evaluated as a material for tissue engineering.

Bioplastic resins include Polylactic acid (PLA), cellulose based PH, polybutylene adipate terephthalate (PBT) and polycaprolate (PCL), from corn and cellulose; green polyethylene, (GPE) and green polyethylene terephthalate (GPET also known as GPETE) from sugarcane; and Poly3-hydoxybutrate-3-hydroxyhexxanate (PHBH) from a fermentation process using glucose and propionic acid as the carbon source for Alcaligenes eutrophus. PHA polyhydroxyalkanoate) is derived by plant fermentation. Poly L lactide (PLLA) and poly D lactide (PDLA) are forms or homo-polymers of PLA. PLA, PDLA, and PLLA are especially compostable and can be degraded to make eco-friendly compost or humus. Bioplastic resins include PLA, PHA, PCL, PH, PBT, GPE, GPET, PHBH, PDLA, and PLLA.

Acetyl tributyl citrate (herein referred to as “ATBC”) is a transparent biodegradable plasticizer having low toxicity. It is also referred to as tributyl acetyl citrate, butyl acetylcitratem, O-acetylcitric acid tributyl ester, ATCB, or acetyl tributylcitrate. It has molecular formula C20H3408.

Bioplastic resins have some distinct advantages over plastic and glass. Bioplastic has a much smaller carbon footprint compared to plastic or glass, and also uses less energy to form an article like a syringe. Bioplastic is biodegradable in an industrial composting unit. Bioplastic resins are from a plant source, and when plants are grown, they absorb carbon dioxide, thus decreasing carbon dioxide in the atmosphere. Plastic and glass disposable items have a higher carbon footprint than bioplastic items.

Currently syringes, when they are disposed of and enter the waste stream, are considered a bio waste. They have to be disposed off in a safe method and may go through incineration. This process is detrimental to the environment in that it causes release of hydrocarbons and toxins into the atmosphere and creates fly ash that ends up in landfills. Bioplastic articles can be sterilized, shredded and composted, thereby bypass this process. Bioplastic articles are environmentally safe and sustainable, when compared to plastic or glass, leading to near-zero waste.

Bioplastic, however, has poor permeability characteristics, in reference to water, oxygen and carbon dioxide. Bioplastic also has poor flexibility properties and is rigid. PLA, a bioplastic, has poor thermal properties, with heat distortion threshold of 55 Celsius, compared to plastics.

It would be desirable to provide disposable items made from flexible bioplastic resins.

### SUMMARY OF THE INVENTION

In one aspect of the present invention, a method includes providing a bioplastic resin, and mixing the bioplastic resin with a biodegradable plasticizer that includes acetyl tributyl citrate (ATBC); thereby providing a flexible biodegradable material.

In another aspect of the present invention, a flexible biodegradable material includes a bioplastic resin and acetyl tributyl citrate (ATBC).

### BRIEF DESCRIPTION OF THE DRAWINGS

FIG. 1 depicts an embodiment of a syringe with attached needle according to the present invention;

FIG. 2 depicts an embodiment of a general purpose syringe and assembly according to the present invention;

FIG. 3 depicts an embodiment of a multi dose syringe and assembly according to the present invention;

FIG. 4 depicts an embodiment of a safety needle cap and shield according to the present invention;

FIG. 5A depicts an embodiment of a specimen tube according to the present invention;

FIG. 5B depicts an alternate embodiment of a specimen tube according to the present invention;

FIG. 6 depicts an embodiment of a scalpel handle and blade according to the present invention;

FIG. 7 depicts an embodiment of a lancet and cross section according to the present invention;

FIG. 8 depicts an embodiment of a sharps container according to the present invention;

FIG. 9 depicts an embodiment of a suction canister with a broad neck according to the present invention;

FIG. 10 depicts an embodiment of a suction canister with a narrow neck according to the present invention;

FIG. 11 depicts a perspective view an embodiment of a toner cartridge with drum according to the present invention;

FIG. 12 depicts a cross section of the embodiment of FIG. 11;

FIG. 13 depicts an embodiment of a ink cartridge with a single reservoir according to the present invention;

FIG. 14 depicts an embodiment of a ink cartridge with multiple reservoirs according to the present invention;

FIG. 15 depicts a perspective view of an embodiment of a pipette according to the present invention;

FIG. 16 depicts a side cross section view of the embodiment of FIG. 15;

FIGS. 16A, 16B, and 16C depict end cross section views of the embodiment of

FIG. 15;

FIG. 17 depicts an embodiment of a vaginal speculum according to the present invention;

FIG. 18 is a perspective view of an embodiment of a bioplastic pharmacy device according to the present invention;

FIG. 19 is an elevation side view of an embodiment of the device of FIG. 18;

FIG. 20A is a side view of an embodiment of a tab and lug device according to the present invention;

FIG. 20B is a cross-section view of the embodiment of FIG. 20A;

FIG. 21 depicts an embodiment of a specimen container according to the present invention;

FIG. 22 depicts an embodiment of a medicine dispensing cup according to the present invention;

FIG. 23 depicts an embodiment of a urinal according to the present invention; and

FIG. 24 depicts an embodiment of a medical band according to the present invention.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

In an embodiment, PLA or heat stable PLA, namely PLLA , PDLA and additives like ATBC are first subject to trace element extraction, to achieve medical grade resin and additives. To this medical grade PLA is added medical grade ATBC in a ratio from 5 to 35% ATBC by weight and mixed in a mixer for 10 minutes. This final medical grade resin granules are then bagged and a batch and a traceable code are printed on each bag and detailed log is kept. This medical grade mix is then used to make medical items like syringes and with a tubular needle cap and a flexible foldable needle safety shield . This mixture is not only limited to such items and can include other medical and non medical items. For the non medical items the PLA and ATBC mix does not have to me medical grade. Both medical and non medical items can be injection or blow molded . Examples include bottles, containers, sharps containers, syringes, test tubes, catheters, IV bags, urinal, prescription bottles, etc.

In an embodiment, plasticizers or additives or both may be added to PLA. ATBC can be added to improve flexibility. To overcome distortion, heat tolerant PLA may be used, such as PLLA and PDLA, to offer higher heat distortion properties. If to be used in the human body, all these materials will be of medical grade to meet FDA approval and standards.

A flexible, biodegradable material may be substantially free of non-biodegradable elements, in that the material will include the bioplastic resin and the ATBC, but will not intentionally or knowingly include additives that are not biodegradable.

An embodiment may include a PLA and ATBC mixture at a ratio of 5 to 35% weight, which produces a bioplastic resin that is flexible and not rigid. The tensile strength of PLA is 36.4 MPa and may be improved to 13.1 MPa, and elongation at break may improve from 7.2% of PLA to 483.5% for the bioplastic mixture. This makes the mixture more flexible. Embodiments of this flexible grade PLA mixture may be injection, blow molded thermoformed, or otherwise molded in many items and articles in daily life that need flexibility or are squeezed, such as shampoo bottles and medicine ointment bottles. Embodiments may be used in daily consumer products that are for either medical or nonmedical use, namely, but not limited to bottles, containers, specimen jars, syringes, scalpels, lancets, urinals , pharmacy prescription bottles, catheters, test tubes, intravenous (IV) lines , IV and blood transfusion bags, ink cartridges and laboratory items and other disposable single use items . The items may be “disposable” because they are biodegradable or at least degradable.

Embodiments of the present invention may provide disposable syringe with a tubular needle cap and a flexible foldable needle safety shield, made from sustainable and environmentally safe bioplastic resins. Embodiments may be made from bioplastic resins, namely, polylactic acid (PLA), polyhydroxyalkonate (PHA), poly 3 hydroxybutrate co 3 hydroxyhexanote (PHBH), and biopolymer poly-3-hydroxybutyrate (PHB), and may have a UV-cured coating.

Embodiments may be made of a flexible bioplastic material that includes polylactic acid (PLA) and acetyl tributyl citrate (ATBC).

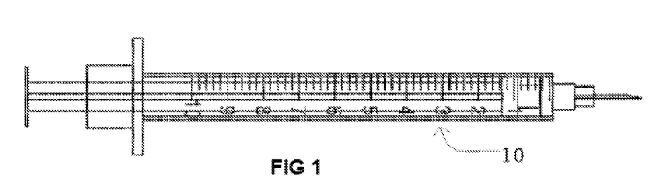

FIG. 1 depicts an embodiment of a bioplastic syringe 10 with attached needle. Embodiments of bioplastic syringes may be used for insulin administration, allergy or tuberculin testing or administration of other parental agents. An embodiment of a syringe 10 may be made from bioplastic, and may have a simple piston pump with a plunger that fits tightly in a tube. The plunger may be pulled and pushed along inside a cylindrical tube (the barrel), allowing the syringe to take in and expel a liquid or gas through an orifice at the open end of the tube. The open end of the syringe may be fitted with a hypodermic needle, a nozzle, or tubing to help direct the flow into and out of the barrel. Embodiments of bioplastic syringes may be used in the medical field to administer injections, insulin administration, skin tests such as allergy tests, and tuberculin testing. In non-medical field uses, non-sterile bioplastic syringes may be used to apply compounds such as glue or lubricant, and measure liquids.

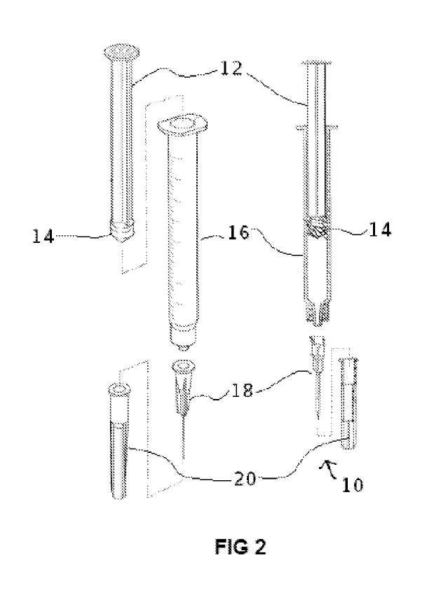

FIG. 2 depicts perspective and cross section views of a general propose disposable single-use syringe 10 that may have a plunger 12 with a rubber tip 14, a cylindrical barrel 16, a hypodermic needle 18 and a needle cap 20. Plunger 12, barrel 16 and needle cap 20 may include or be made from bioplastic resin.

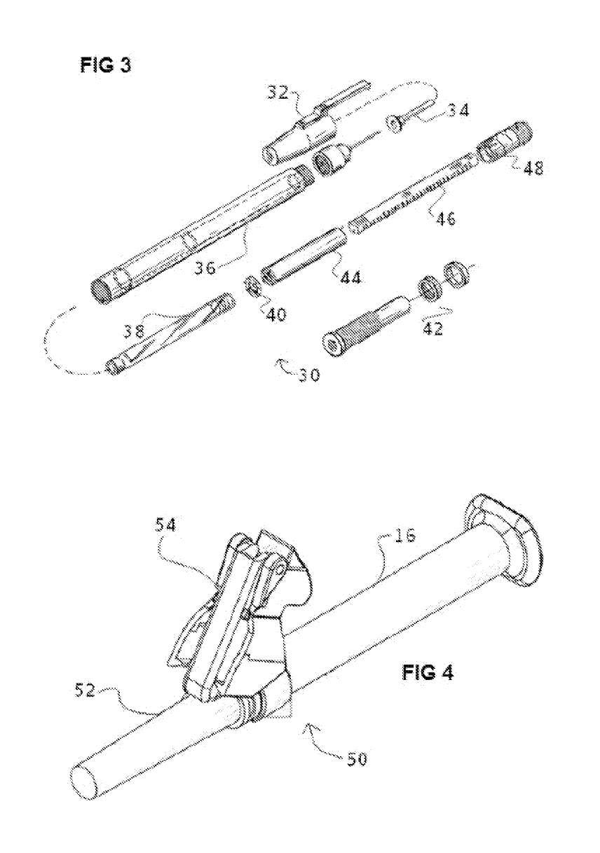

FIG. 3 depicts an embodiment of a multidose syringe assembly 30 or dispenser that may have a pen cap 32, a needle cap 34, a housing cylinder 36, a collar 40, and collar assembly 42, cylinder tube 44, piston plunger 46 and a numerically calibrated cap 48, all of which may include or be made from bioplastic resin. Housing cylinder 36 holds a prefilled vial 38 that contains fluid. An embodiment of a syringe assembly 30 or dispenser may have the general appearance of a pen. A pen-like dispenser may be large enough to hold several doses, yet be small enough to fit conveniently in a user's pocket or purse, such as, for example, from 5½″ long to 7″ long. An embodiment of a pen-like dispenser may include several parts all made from bioplastic, perhaps other than a prefilled vial that holds the liquid agent.

FIG. 4 depicts an embodiment of a safety needle cap and shield assembly 50, which may include a needle cap 52 and a needle safety shield 54 attached to the syringe cylindrical barrel 16, all of which may include or be made from bioplastic resin. An embodiment of a syringe needle assembly may include a syringe fixed to a medical or hypodermic needle. An embodiment of a bioplastic cap and a safety shield assembly 50 may attach to the syringe needle assembly, to help provide protection from a sharpened tip of the needle. The cap 52 may be removed before using the syringe needle assembly. After using the syringe needle assembly, the safety shield 54 may be deployed. The safety shield 54 may be foldable or may include a tubular assembly, thereby providing a safety sheath for the needle. This may help guard against problems associated with inadvertent needle sticks related to blood sampling, percutaneous medication injection and other medical procedures involving uses of medical needles.

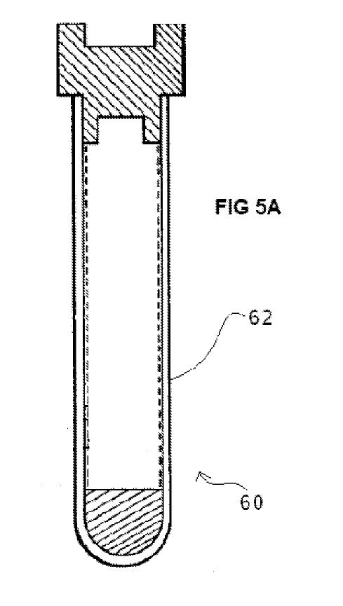

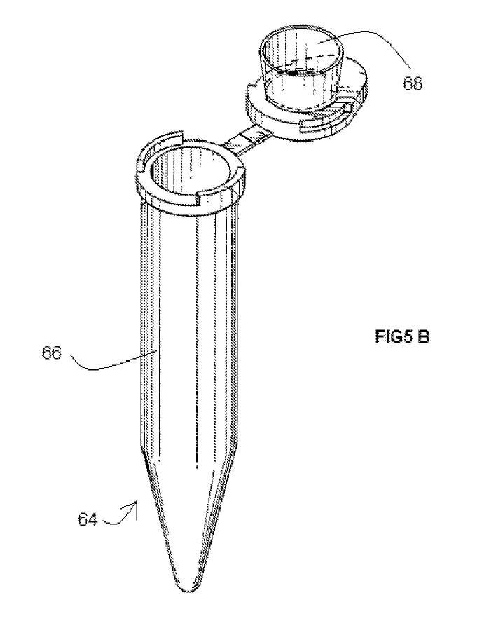

FIG. 5A depicts an embodiment of a specimen tube 60. The tube 60 may have walls 62 that include a bioplastic resin and are adapted to contain blood.

FIG. 5B depicts an alternate embodiment of a specimen tube 64. The tube 64 may have walls 66 and a cap 68 that include a bioplastic resin and are adapted to contain human or other biological specimens, such as for use in a centrifuge.

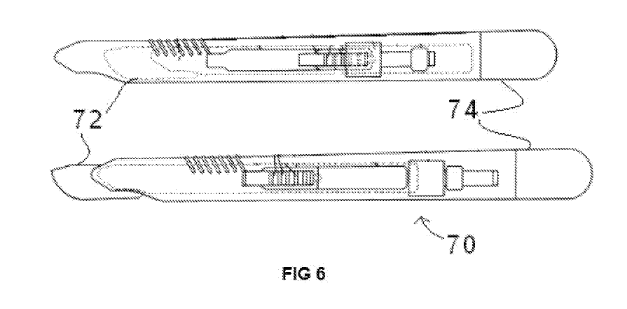

FIG. 6 depicts an embodiment of a scalpel 70, which may include a blade 72 in a retractable safety handle 74. Handle 74 may include a bioplastic resin. An embodiment of a scalpel may be a small and extremely sharp bladed instrument used for surgery, anatomical dissection, and various arts and crafts. Embodiments of scalpels may be disposable and single-use, with a safety retractable blade that can be refracted and extended in and out of a bioplastic handle.

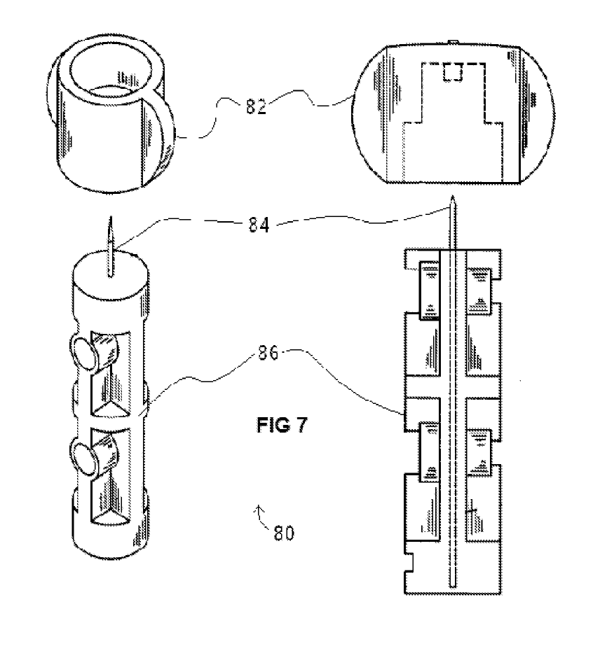

FIG. 7 depicts an embodiment of a lancet 80, which may include a safety cap 82, a needle with a piercing tip 84, and a body 86. Safety cap 82 and body 86 may include bioplastic resin. An embodiment of a disposable lancet 80 may be used to make punctures to obtain small blood specimens. An embodiment of a lancing device may be a reusable instrument equipped with a bioplastic lancet 80.

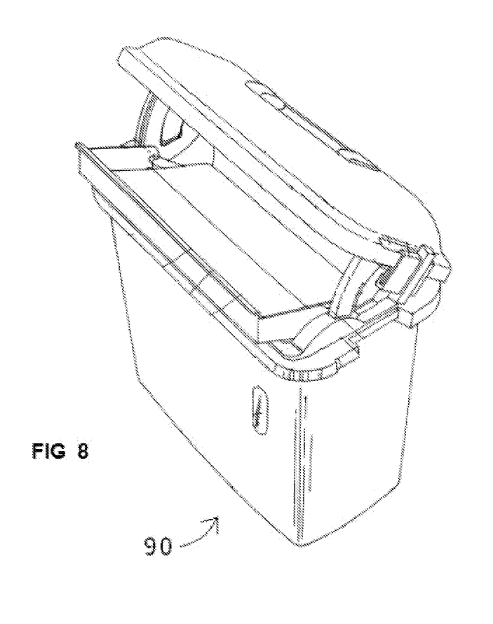

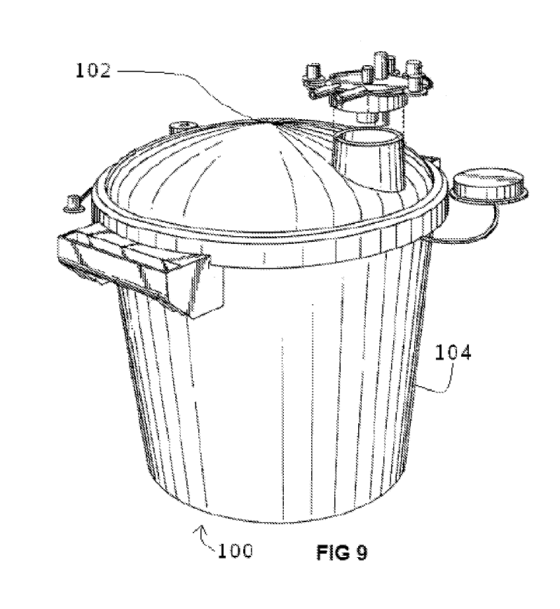

FIG. 8 depicts an embodiment of a sharps container 90, which may include or be made from bioplastic resin.

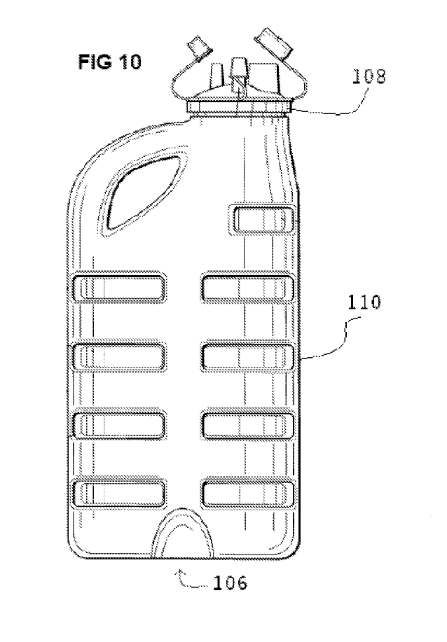

FIG. 9 depicts an embodiment of a broad neck suction canister assembly 100 with a cap 102 and broad neck receptacle 104. FIG. 10 depicts an embodiment of a narrow neck suction canister assembly 106 with a cap 108 and narrow neck receptacle 110. The caps 102, 108 and receptacles 104, 110 may include or be made from bioplastic resin.

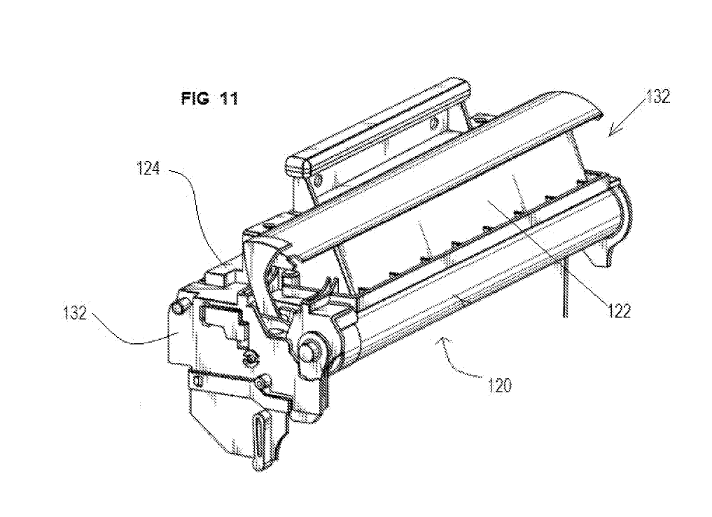

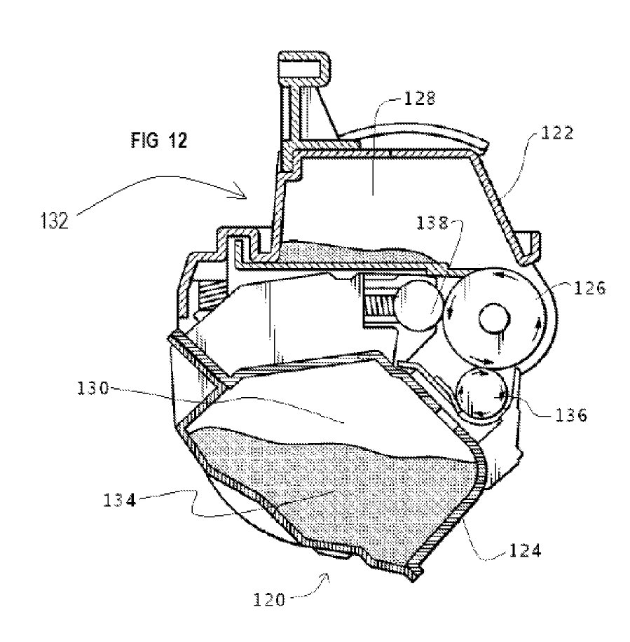

FIGS. 11 and 12 depict an embodiment of a toner cartridge 120. Toner cartridge 120 may include a first casing part 122 and a second casing part 124, which are separable from each other. First casing part 122 may have a photosensitive drum 126 that retains an electrostatic latent image on its surface and a waste toner unit 128 that removes and collects toner remaining on the surface of photosensitive drum 126. Second casing part 124 may have a toner hopper 130 that contains toner 134, a magnet roller 136 that supplies toner from toner hopper 130 to photosensitive drum 126, and which develops the electrostatic latent image on a charging roller 138 that uniformly charges the surface of photosensitive drum 126. Embodiments may include side plates 132 that are shaped to help hold the first casing part 122 to the second casing part 124 and which have features and apertures to help retain the elements inside the toner cartridge 120 in their proper positions. Toner cartridge 120 may be assembled from first part 122, second part 124, and left and right side plates 132. Toner cartridge 120, first casing part 122, second casing part 124, and side plates 132 are made from bioplastic resin.

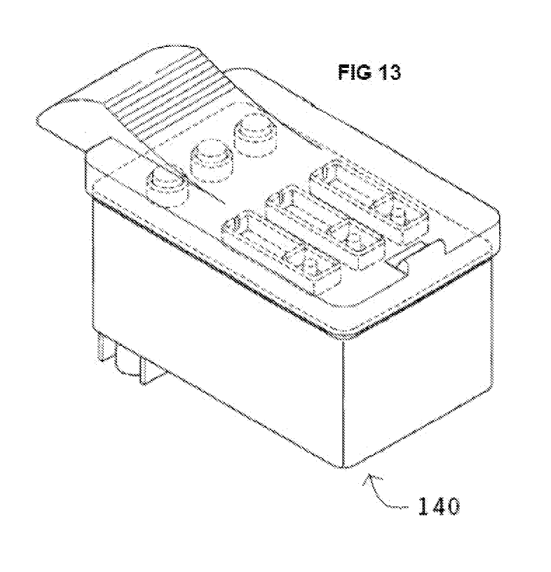

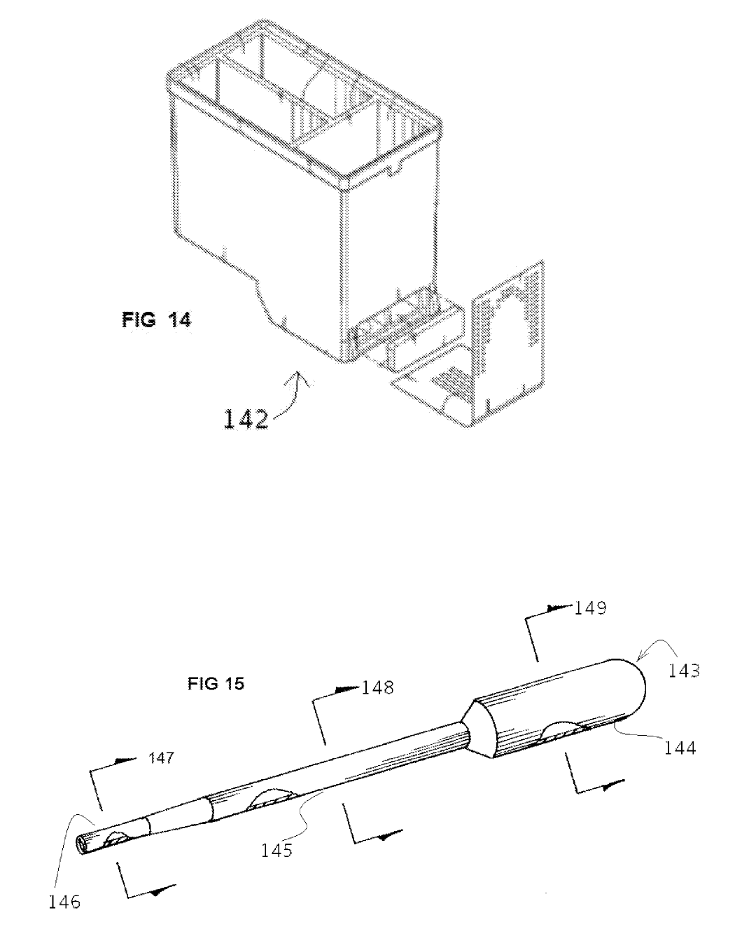

FIG. 13 depicts an embodiment of an ink cartridge with a single reservoir 140. FIG. 14 depicts an embodiment of an ink cartridge with multiple reservoirs 142. Embodiments of bioplastic ink and toner reservoirs may be used in printer and copy machines. Ink reservoirs 140 and 142 may include or be made from bioplastic resin and may be attached to a base that can include electronic, plastic, or bioplastic parts or materials.

Disposable pipettes and pipette tips are an instrument used to transport a measured volume of liquid, and may commonly be used in medical, pharmaceutical , microbiology and chemistry labs. A disposable pipette is made of plastic and consists of a hollow, a bulb section at one end with a hollow tubular section. The hollow tubular section at the opposite end may have a tapered open mouth. The bulb section is used for handling the pipette, and may be generally rigid, but compressible when squeezed. A pipette tip consist of an open hollow tubular section with a tapered narrow end at the opposite end.

FIG. 15 depicts an embodiment of a pipette. Pipette 143 may include a bulb section 143 at a first end, which may be generally rigid but compressible. Hollow tubular section 145 may have a tapered open mouth 146 at a second end. Bulb section 144 may have a first, largest size 149, tubular section 145 may have a second, middle size 148, and mouth 146 may have a third, smallest size 146.

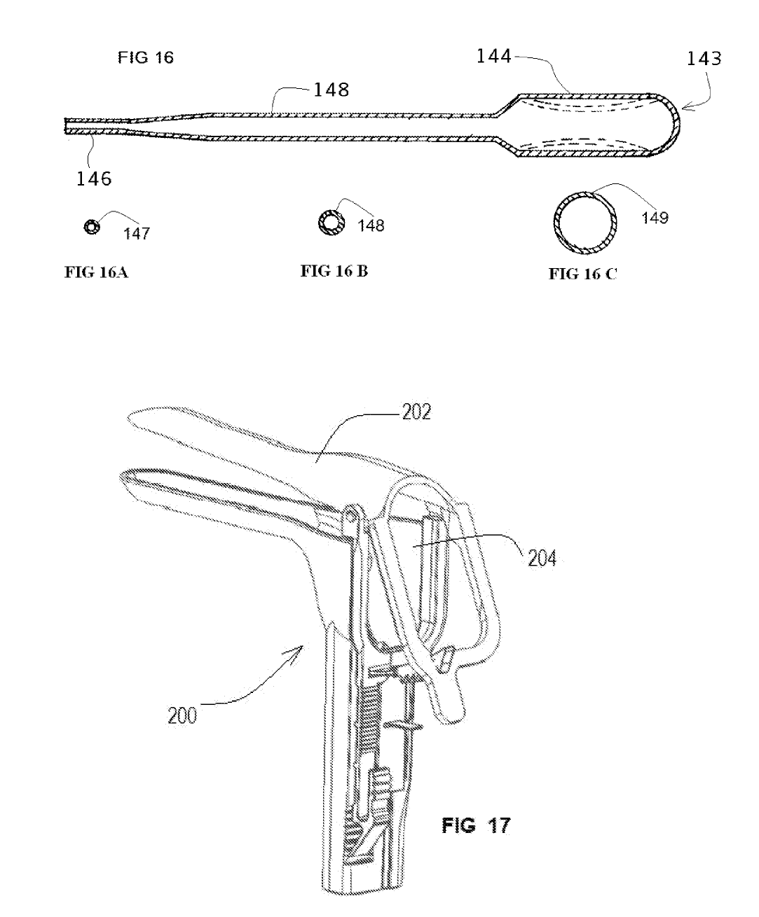

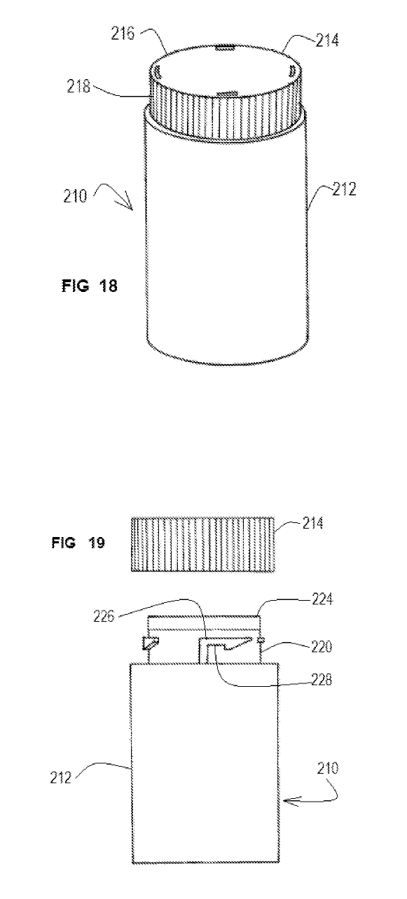

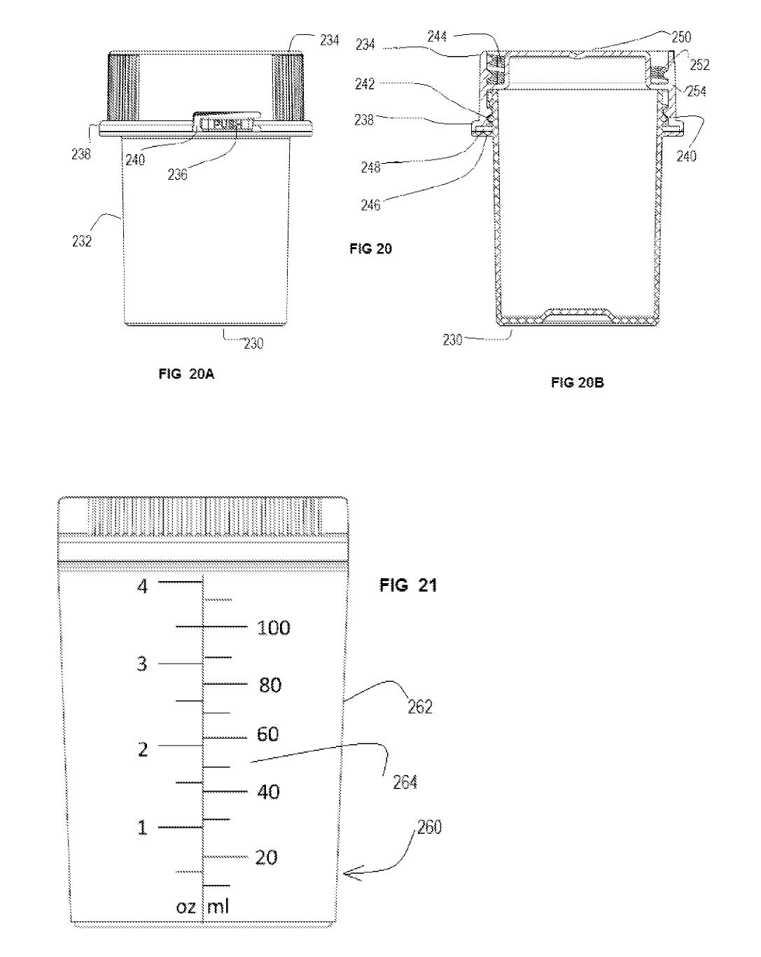

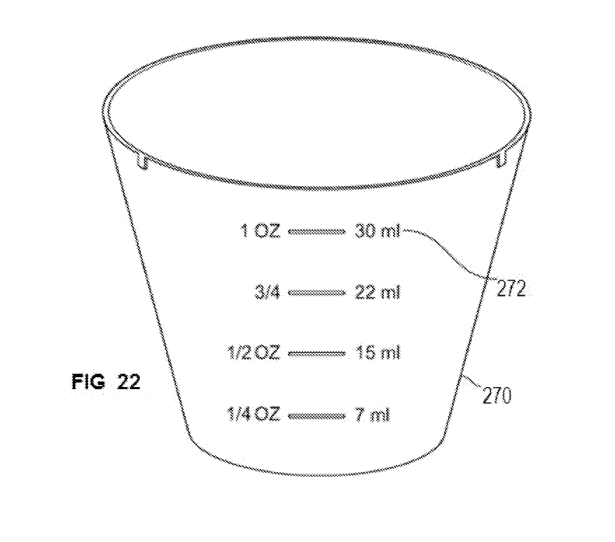

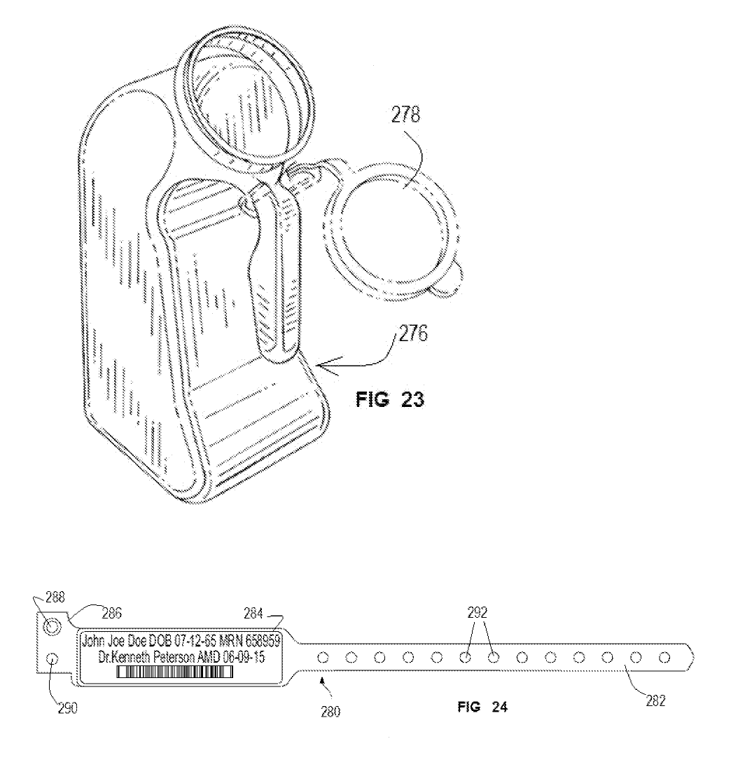

FIG. 16 shows that the bulb section 144 may have sides that compress together when squeezed and expand apart when released, thereby allowing a user to control the amount of liquid in the pipette 143. FIGS. 16A, 16B, and 16C show that an embodiment of a pipette may have a mouth size 147, a tubular section size 148, and a bulb section size 149. The embodiments described are not intended to be limited to the pictured shapes, sizes and orientations.

A vaginal speculum is a diagnostic instrument for dilating the opening of the vaginal cavity in order that the interior may be more easily visible for observation. Embodiments of vaginal speculum include the bivalve vaginal speculum; the two blades, an upper and a lower, are hinged and are “closed” when the speculum is inserted to facilitate its entry and “opened” in its final position. A vaginal speculum may have a third part, the forked connector portion, and the set of blade pairs attached to the distal end of the forked connector. Both pairs of the blades may have snapping engagement with the handle on the locking mechanism. The blades distal ends may be connected to the forked connector. The whole speculum may be disposable after single use. The lower blade acts as part of the handle and may house a portable or rechargeable light or illumination device. The illumination device can be mounted on either blade and may not be portable and connect to wall unit for power. The speculum may vary in size from small (W ⅞×L 4 inches), medium (W 1⅛×L 4 inches) to large (W 1⅜×L 4½ Inches).

As depicted in FIG. 17, an embodiment of the present invention may include a vaginal speculum 200. The vaginal speculum 200 may be made of bioplastic materials may include three components which are assembled to make the vaginal speculum. The components may include a translucent upper blade 202, a translucent lower blade and handle portion 204, and a forked connector which may be translucent or opaque. Upper blade 202 may form a dome and lower blade 204 may form a trough. Embodiments of a vaginal speculum may bear a compostable symbol.

An embodiment of a device for storing medicine may include a container and a safety cap. An embodiment of a safety cap may include a circumferential outer skirt and a circumferential, resilient, inner member. An embodiment of a container may have a rigid wall having an end for engagement with the cap internally of the cap's outer skirt, along a closure plane. The wall of the container may engage internally with the resilient inner member of the cap and expand the resilient inner member outwardly to provide a working seal of the container. The container and the safety cap may be bioplastic resin, and the resilient inner member may be bioplastic resin or another biodegradable, resilient material that could be used as a gasket to store medicine.

As depicted in FIG. 18, an embodiment of a device 210 may include a bioplastic container 212 and a bioplastic safety cap 214. The safety cap 214 may have a circumferential outer skirt 218 for engaging container 212 in a closure plane 216 to lock the container. Embodiments of a pharmacy container 212 and safety cap 214 may be made from bioplastics, namely, polylactic acid, polyhydroxyalkonate (PHA), poly 3 hydroxybutrate co 3 hydroxyhexanote (PHBH), and biopolymer poly-3-hydroxybutyrate (PHB), and may have a UV-cured coating. Embodiments may be made of a flexible bioplastic material that includes polylactic acid (PLA) and acetyl tributyl citrate (ATBC).

As depicted in FIG. 19, an embodiment of a bioplastic container 212 may include a rigid side wall 220 for engagement with the cap 214 internally of the outer skirt 218. Side wall 220 may have an end section 224 which fits within a resilient member of the cap 214 when the cap 214 is secured to the container 212. Cap removal prevention or other locking elements on the container may include a latch 226 having a receiving notch 228, adapted to engage with cooperating elements such as a lock lug in the cap.

As depicted in FIG. 20A, an embodiment of a device 210 may include a bioplastic container 232 and a bioplastic reversible cap 234. The cap 234 may be dual sided, having a child resistant side and an elderly friendly side, each with its own set of threads to engage with the container. The child resistant side of the cap 234 may have a push button 236 on a child-resistant-side rim 238 that operates a locking tab 68 to provide a child resistant lock when the device is in a child-resistant orientation.

As depicted in FIG. 20B, an embodiment of a container 232 may have a tubular threaded top 242. When the device 210 is in a child-resistant, closed position, the cap 234 may sit on the container 232 so that reciprocal child-resistant-side threads 244 in the child resistant side of the cap 234 engage with the tubular threaded top 242. The top of the container 232 may further have a container skirt 246 with a lug 248, which cooperates with the locking tab 240 on the child-resistant-side rim 238 of the cap 234 to prevent retrograde rotation of the cap and provide child resistant lock. The elderly friendly side of the cap 234 may be opposite the child resistant side, and may have a flat top 250, and reciprocal elder-friendly-side threads 252 located within the outer rim 254.

A specimen container is commonly used to collect urine, faces, human body tissue or biopsy tissue. A human biological specimen container is very specific and will usually vary in size from 2 to 4 oz. The lateral wall has a graduated marking in ounces or milliliters ranging from 0-4 oz., or 0 to 120 ml. An embodiment may have the shape depicted in the figures. The container can be non-sterile or sterile and individually packed in a sterile pouch. The specimen container can be empty or can have a reagent like formaldehyde.

As depicted in FIG. 21, an embodiment of a specimen container 260 for human biological specimen collection may include a cap and vial made substantially or entirely of injection molded bio resins. The cap and vial may be colored green and may bear a compostable symbol. A vial 262 may have a capacity of 2 to 4 oz. in size and may have graduated measurements 264 for volume marked on the side of the vial 262. Embodiments of graduated measurements 264 may indicate volume levels from 0 to 4 oz. or 0 to 120 ml. or both so that a user may see the level and thereby determine the volume of specimen in the container.

Embodiments of a medicine dispensing cup may be intended to be used for portioning medicine in a solid or liquid state, usually one to two fluid ounces or one or several tablets or capsules. The medicine cup may be made from paper or plastic namely polypropylene. The medicine dispensing cup may include a wall having a cross section which conically decreases from a top open edge towards a closed bottom edge. The top edge forms an open aperture, and has a wall integral with the top edge. The wall may have a cross section that conically decreases from said top edge towards said closed bottom, until the wall merges into a closed bottom. The space from said open top to the closed bottom is a distance that may be at least one-half the total distance between said top edge and bottom. The cup may be or not marked on the lateral wall with graduated marking in millimeters, ounce or drams. Example cups may vary in size from one ounce to eight ounces. Embodiments may include a lid to cover the open aperture. The lid shape is related to the conical angle of said outer top open aperture wall of the cup. In embodiments, the medicine cup may made from bio resins such as PLA (PLLA and PDLA).

As depicted in FIG. 22, an embodiment of a medicine cup 270 or other measuring cup may be injection molded using bio plastic resins. Embodiments may include a cup shaped, truncated cone, having a flat bottom that widens to an open top. The cup 270 may be marked with graduated measurements 272 that indicate the volume of material in the cup based upon the level. Since the sides of the cup are slanted outwards, graduates measurements 272 with consistent volume spacing will tend to be closer together near the top of the cup. Graduated measurements 272 may include horizontal lines drawn or etched onto the cup 270 with appropriate labels. Graduated measurements 272 may indicate where the volume would be 1, ¾, ½, and ¼ oz., or 30, 22, 15, and 7 ml., or both.

A urinal is commonly used in health care facilities to safely collect, temporarily store and dispose urine form patients. This type of urinals are in widespread use and are manufactured by blow-molding from a suitable polymer, such as polyethylene, so as to have a body having a lower wall, an upper mouth, and front, side, and back walls and so as to have a unitary handle projecting from the body, near the upper mouth, toward a lower portion of the front wall, whereby a gap is defined between the handle and an upper portion of the front wall. Commonly, a urinal of the type noted below is provided with a cap, which is adapted to be snap-fitted around a margin of the upper mouth and which is attached to the handle, where the handle meets the body, via a tether that is unitary with the cap. The urinal may be or not marked on the lateral wall with graduated marking in millimeters or ounce. The size and shape of the urinal can vary. In this embodiment the urinal is made from bio resins, namely PLA (PLLA and PDLA).

As depicted in FIG. 23, an embodiment of a urinal 276 may be blow molded using bioplastic resin. A urinal 278 may include a urine collection bottle with a canted opening near the top and a handle. Embodiments may include a cap which may have an elongated tab that flexibly attaches to the bottle.

Identification bands for patients (IBP), are generally made from vinyl or other plastic material. These IBP may be formed in sheets with adjacent IBP being flipped end-to-end to allow them to nest and thereby save on wasted material. The snap closures are also generally made of plastic and are mounted in a “toe” vinyl extension from the panel side opposite the strap. This toe extension generally comprises a tab portion aligned with and opposite to the strap and within which the snap closure is located. The snap closure includes a pin centered along the same center axis as the strap, which centers the snap closure to the panel and strap holes so that when the IBP is applied by attaching the strap to the snap closure the strap remains aligned with the panel. The IBP can be applied using a thermal adhesive closure. Typical size for adult IBP is 11 inches×1¾ inches, and infant or child IBP is 8×¾ inches. The size, shape and color can vary. On the tail or patient information area, a printed bar code and or serialized alphanumeric codes can be printed or paper label applied. This ensures maximum safety and provides scan ability.

As depicted in FIG. 24, an embodiment of a medical band 280 may include a disposable, adjustable bracelet for a user's wrist or ankle. The medical band 280 may have an adjustable portion 282 that wraps around and attaches to the band 280, and a label portion 284 that includes patient information such as text or a barcode. A tab 286 at one end may include a reinforced aperture or lanyard 288. The tab 286 may also have a peg 290 that adjustably attaches to a one of series of holes 292 in the adjustable portion 282, to adjust the size of the band 280.

Disposable items made from bioplastic resins include a biodegradable resin and a plasticizer. The resin and plasticizer are intermixed to provide a bioplastic. A disposable device may include a syringe, a multidose syringe, a needle cap and needle safety shield, a specimen tube, a scalpel, a lancet, a sharps container, a suction canister, an ink cartridge, or a toner cartridge. The bioplastic may include Polylactic Acid (PLA) or Polyhydroxyalkonoate (PHA). A method of disposing of an item includes providing a bioplastic, the item including or made of the bioplastic; sterilizing the item utilizing steam, radiation, or ethylene oxide gas; shredding the item; and composting the item into a compost end product, thereby disposing of the item.

I claim:

1. A method comprising:
providing a bioplastic resin; and
mixing the bioplastic resin with a biodegradable plasticizer that includes acetyl tributyl citrate (ATBC);
thereby providing a flexible biodegradable material.

2. The method of claim 1 wherein the bioplastic resin is polylactic acid (PLA).

3. The method of claim 1 wherein the flexible biodegradable material is 5 to 35% ATBC by weight, and the material is substantially free of non-biodegradable elements.

4. The method of claim 1, further comprising:
forming a desired shape by injection molding, blow molding, or thermoforming the flexible biodegradable material into the desired shape, thereby providing a flexible and biodegradable device.

5. The method of claim 1, further comprising:
forming the flexible biodegradable material into a device; wherein
the bioplastic resin is polylactic acid (PLA); and
the flexible biodegradable material is 5 to 35% ATBC by weight.

6. The method of claim 5, wherein the device is a syringe.

7. The method of claim 5, wherein the device is a multidose syringe.

8. The method of claim 5, wherein the device includes a needle cap and needle safety shield.

9. The method of claim 5, wherein the device is a specimen tube.

10. The method of claim 5, wherein the device is a scalpel.

11. The method of claim 5, wherein the device is a lancet.

12. The method of claim 5, wherein the device is a sharps container.

13. The method of claim 5, wherein the device is a suction canister.

14. The method of claim 5, wherein the device is an ink cartridge

15. The method of claim 5, wherein the device is a toner cartridge.

16. The method of claim 1, further comprising:
forming the flexible biodegradable material into a device;
sterilizing the device utilizing steam, radiation, or ethylene oxide gas;
shredding the device; and
composting the device into a compost end product, thereby disposing of the device.

17. A flexible biodegradable material comprising:
a bioplastic resin; and
acetyl tributyl citrate (ATBC).

18. The material of claim 17, wherein:
the bioplastic resin is polylactic acid (PLA); and
the flexible biodegradable material is 5 to 35% ATBC by weight.

19. The material of claim 18, wherein material is molded into an item selected from the group consisting of: a syringe, a multidose syringe, a needle cap and needle safety shield, a specimen tube, a scalpel, a lancet, a sharps container, a suction canister, an ink cartridge, and a toner cartridge.
